(19) United States
(12) Patent Application Publication
(10) Pub. No.: US 2012/0054000 A1
(43) Pub. Date: Mar. 1, 2012

(54) REWARDS PROGRAM BONUS

(75) Inventors: Mary Beth Boppert, Maplewood, NJ (US); Victor Colombo, New York, NY (US); Christine C. Etheredge, New York, NY (US); E Bai Koo, New York, NY (US); Silvia Mansur de Oliveira, New York, NY (US); Denee C. Perry, Brooklyn, NY (US)

(73) Assignee: American Express Travel Related Services Company, Inc., New York, NY (US)

(21) Appl. No.: 12/873,992

(22) Filed: Sep. 1, 2010

(51) Int. Cl. G06Q 30/00

(52) U.S. Cl. 705/14.1

(57) ABSTRACT

A system and method for managing a rewards program is disclosed. A reward redemption request is provided in exchange of reward points accrued by a customer. Based on the redeemed reward points, the customer is provided a redeemed reward. The redeemed reward is compared with redemption criteria. The redemption criteria may be based on the amount of redeemed reward points and/or the redeemed reward. In response to meeting the redemption criteria, the reward redemption may qualify for a rewards program bonus.

### FIELD OF THE INVENTION

The present invention relates generally to a rewards system, and more particularly, to managing a rewards program bonus in a transaction system.

### BACKGROUND OF THE INVENTION

The popularity of transaction accounts has increased in recent times. Transaction accounts may be associated with transaction instruments, wherein the transaction instruments encompass a variety of payment vehicles such as, credit cards, debit cards, smart cards, or the like. The payment vehicles often provide an easy, convenient and safe mode of payment to a customer. The customer may conduct transactions related to the purchasing of a host of products and/or services with a line of credit and/or a transaction account that may be associated with the transaction instrument.

However, in an era of increased competition, satisfied customer acquisition is often the differentiating factor that is responsible for creating a loyal and profitable customer relationship. Moreover, the primary challenge typically faced by companies is providing services that meet the customer's needs. Hence, customer satisfaction is usually a focus to prevent customer attrition. Credit aversion factors (such as rise in annual percentage rate payable by the customer, increased interest rates, additional fees associated with using the payment card etc.) may be responsible for the increase in customer attrition.

Thus, to reduce attrition, the customer is often provided with a host of fringe benefits, more purchasing power, air miles reward points or the like on daily transactions etc. Further, transaction account companies usually provide the customer with opportunities to earn and accrue reward points on their transactions, associated with various rewards programs. Rewards programs often allow the customer to accrue reward points proportionate to the amount of transactions executed by the customer. The transaction card companies usually promote the use of a transaction account by providing the customer benefits via the rewards programs. Moreover, some of the rewards programs provide different benefits according to the type of transaction instrument or transaction account associated with the customer and/or purchase.

Even though a variety of rewards programs (e.g., cash back rewards, frequent flyer rewards, frequent shopper rewards, mobile phone usage rewards, fuel point rewards or the like) are available, there is a long-felt need to meet the customers increasing expectations, in order to increase the customer's satisfaction and retention. Therefore, there is a need to provide the customer with improved transaction related benefits.

### SUMMARY OF THE INVENTION

The present invention meets the above-identified need by providing methods, systems, and computer readable storage mediums for managing a rewards program. The method may include receiving a request for reward redemption in exchange for reward points, providing the redeemed reward, comparing the redeemed reward with redemption criteria and determining that at least one of the redeemed reward or the reward points qualify for a rewards program bonus. In response to one of the redeemed reward or the rewards points qualifying for the rewards program bonus, a rewards program bonus is issued.

Further features and advantages of the present invention, as well as the structure and operation of various embodiments of the present invention, are described in detail below with reference to the accompanying drawings.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an exemplary environment in which a rewards program system may be deployed, in accordance with various embodiments of the present invention;

FIG. 2 is a block diagram illustrating an exemplary implementation of a rewards program module, in accordance with various embodiments of the present invention;

FIG. 3 is exemplary situations for managing a rewards program bonus, in accordance with various embodiments of the present invention;

FIG. 4 is an exemplary transaction account statement, in accordance with various embodiments of the present invention;

FIG. 5 is a process flow diagram showing an exemplary process for managing a rewards program, in accordance with various embodiments of the present invention; and

FIG. 6 is a block diagram of an exemplary computer based system for implementing the present invention, in accordance with various embodiments of the present invention.

### DETAILED DESCRIPTION OF EXEMPLARY EMBODIMENTS

The detailed description of exemplary embodiments of the invention herein makes reference to the accompanying drawings and figures, which show the exemplary embodiments by way of illustration only. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented. Moreover, many of the functions or steps may be outsourced to or performed by one or more third parties. Furthermore, any reference to singular includes plural embodiments, and any reference to more than one component or step may include a singular embodiment or step.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention is described herein with reference to system architecture, block diagrams and flowchart illustrations of methods, and computer program products according to various aspects of the invention. It will be understood that each functional block of the block diagrams, screenshots and the flowchart illustrations, and combinations of functional blocks in the block diagrams, screenshots and flowchart illustrations, respectively, can be implemented by computer program instructions.

A “customer” may possess one or more transaction accounts which may be associated with one or more transaction instruments. The transaction instruments may include, but are not limited to, credit cards, change cards, debit cards, smart cards or the like; that are correspondingly associated with a line of credit and/or a transaction account. The customer may purchase goods and/or services via a payment transaction gateway.

A “card issuer” may be any entity that may maintain the line of credit and/or transaction account for the customer. The line of credit and/or transaction account may facilitate the customer conducting financial transactions. One example of such entity is American Express, or any other company that provides its customers with payment cards and thereby maintains the corresponding line of credit and/or transaction account.

Additionally, the transaction account may be owned by the customer. The payment transactions made by the customer using the payment card are correspondingly reflected in the credit line and/or transaction account balance.

A “rewards program” may involve processing a transaction/purchase in exchange of rewards points accumulated in the reward account of the customer. The customer may be provided with a redeemed reward, based on the transaction/purchase in exchange of the redeemed reward points. The reward points may include, for example, vouchers, airline miles, vehicle miles, travel credits, loyalty points, discounts, prizes, a monetary value based on a conversion ratio such as cash back, or the like. For example, on purchasing entertainment tickets worth $100, a rewards program may debit 200 reward points from the reward account of the customer.

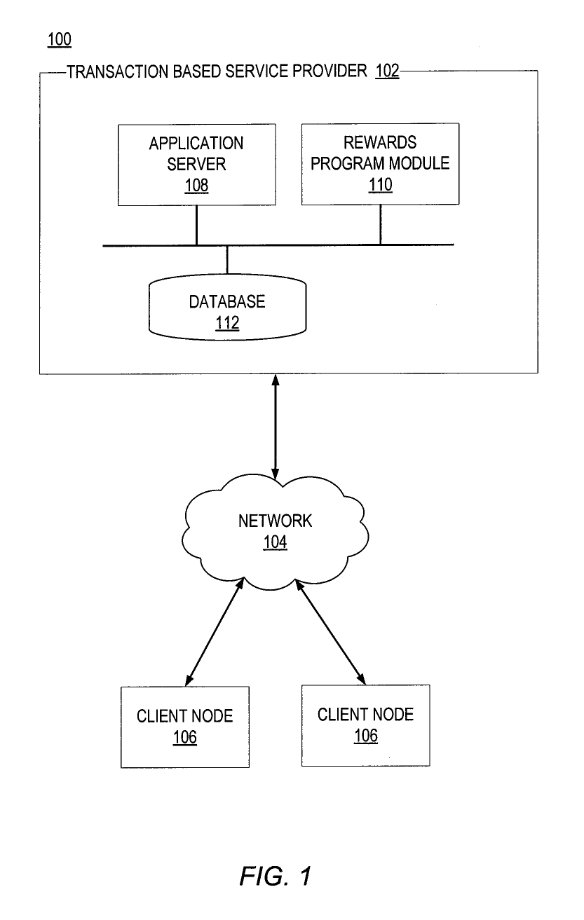

With reference to FIG. 1, in one embodiment, the system includes an implementation of a network environment 100 in which various implementations of the present invention may be deployed. Network environment 100 may include a transaction based service provider 102, a network 104, and one or more client nodes 106. Network 104 may generally represent one or more interconnected networks, over which transaction based service provider 102 and client nodes 106 communicate with each other. Network 104 may include, but is not limited to, packet-based wide area networks (such as the Internet), local area networks (LAN), private networks, wireless networks, satellite networks, cellular networks, paging networks, or the like. Those of ordinarily skill in the art will recognize that network 104 may also be a combination of more than one type of networks. For example, network 104 may be a combination of a LAN and the Internet. In addition, network 104 may be implemented as wired network, a wireless network or a combination thereof.

Client nodes 106 may be computing devices from which a customer accesses the services provided by transaction based service provider 102. Client nodes 106 may have the capability to communicate over network 104. Client nodes 106 may also provide an interface to the user to interact with the services provided by transaction based service provider 102. Client nodes 106 may be, for example, a desktop computer, a laptop computer, a mobile phone, Personal Digital Assistant (PDA), or the like. Client nodes 106 may execute one or more client applications such as, without limitation, a web browser to access and view content over a computer network, an email client to send and retrieve emails, an interface facilitating telephonic calls and the like. Further, client nodes 106 may include a Wireless Application Protocol (WAP) browser or other wireless or mobile device protocol suites such as, without limitation, Nippon Telegraph and Telephone (NTT) DoCoMo's i-mode wireless network service protocol suites, Enhanced Data rates for GSM Evolution (EDGE), or the like.

Further, client nodes 106 may include a Point of Sales (POS) device, such as a POS device deployed at a merchant's establishment. Transactions may be conducted by providing the transaction account number to the POS device of the merchant. The POS device may be any device or system, capable of communication with a payment gateway, a merchant server or the like, to facilitate the transaction.

The customer may purchase products and/or services from the merchant such as, for example, a third party service provider, a franchised vendor or the like via payment transactions. The merchant may be any entity that is a provider, broker and/or any other entity in the distribution chain of products and/or services. For example, the merchant may be, but is not limited to, a retail store, a travel agency, a restaurant, a hotel, a service provider, an on-line merchant, or the like.

Client nodes 106 may be responsible for sending a reward redemption request to transaction based service provider 102 and suitably receiving the redeemed reward and/or receiving appropriate notifications related to the redeemed reward.

Transaction based service provider 102 may be a network addressable system that further includes an application server 108, a rewards program module 110 and a database 112. Application server 108 may provide access to one or more client nodes 106 via network 104. Application server 108 may include any hardware and/or software suitably configured to provide support for at least, maintaining credit and/or debit details related to a transaction account and/or a reward account, associated with one or more payment transactions and/or the reward redemption requests made by the customer. Application server 108 may communicate with any number of other servers, databases and/or components through any means known in the art.

In an embodiment, application server 108 may include a registration and authentication server (not illustrated in FIG. 1), which facilitates the registration of new customers and authenticates existing customers via a sign-in process. The authentication server may include any hardware and/or software suitably configured to receive authentication credentials, encrypt and decrypt credentials, authenticate credentials, and/or grant access rights according to pre-defined privileges attached to the credentials. The authentication server may grant varying degrees of application and data level access to the customers based on information stored within database 112.

Application server 108 may provide an indicia changes to the customer's transaction account balance and/or credit line balance corresponding, but not limited to, successful payment transactions conducted by the customer via the transaction account. Further, application server 108 may also authenticate the payment transaction using customer data stored in database 112, in order to facilitate the successful completion of the payment transaction.

Database 112 may include any hardware and/or software suitably configured to facilitate storing information associated with the customers registered with transaction based service provider 102. More particularly, database 112 is used to store the customer data such as, but not limited to, customer profile data, transaction account details and/or credit line details, customer related personal information and the like.

The customer profile data may include, but is not limited to, the name, age, email, telephone number, address, details of the type of payment card associated with the customer, amount of credit allowable, rate of interest charged or the like. In various embodiments, the transaction account details may include, for example, transaction account number, payment card number operative on the transaction account, beneficiaries of the transaction account, particulars related to all debit and/or credit transactions made from or to the transaction account using the payment card and/or other agreed upon operation modes or the like.

Database 112 may employ any type of database, such as relational, hierarchical, graphical, object-oriented, and/or other database configurations. Common database products that may be used to implement the databases may include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables may be preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/DEC 7816-4 file structure; implementing a domain whereby a dedicated file may be selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats may be facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using one of fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that may be stored using different data storage formats and/or techniques. Further, each data set may contain subsets of data that also may be distinct from other subsets.

As stated above, in various embodiments of database 112, the data can be stored without regard to a common format. However, in one exemplary embodiment of the present invention, the data set (e.g., BLOB) may be annotated in a standard manner when provided for manipulating the data onto the financial transaction instrument and/or to the transaction account. The annotation may comprise a short header, trailer, or other appropriate indicator related to each data set that may be configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, customers or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate. The data, including the header or trailer may be received by a stand-alone interaction device configured to add, delete, modify, or augment the data in accordance with the header or trailer. As such, in one embodiment, the header or trailer may not be stored on the transaction device along with the associated issuer-owned data but instead the appropriate action may be taken by providing to the transaction account holder at the stand-alone device, the appropriate option for the action to be taken. Database 112 contemplates a data storage arrangement wherein the header or trailer, or header or trailer history, of the data may be stored on the transaction instrument in relation to the appropriate data. One skilled in the art will also appreciate that, for security reasons, any databases, systems, devices, servers or other components of database 112 may consist of any combination thereof at a single location or at multiple locations, wherein each database or system includes any of various suitable security features, such as firewalls, access codes, encryption, decryption, compression, decompression, and/or the like.

With renewed reference to FIG. 1, rewards program module 110 may be communicatively coupled to database 112, to retrieve the information associated with the customer. Further, rewards program module 110 may facilitate the management of reward points accrued with the successful completion of the one or more payment transactions completed by the customer. Rewards program module 110 may credit an appropriate amount of reward points, based on a variety of factors such as, for example, the type of transaction instrument, type of transaction account, amount of transaction made, presence of introductory or discount offers and/or the like. Also, rewards program module 110 may be responsible for redeeming reward points, based on a request from the customer, in exchange of a redeemed reward or settling an outstanding balance or the like. In an embodiment, the rewards program module 110 is associated with a reward account and/or the transaction account, which stores the accrued reward points for the customer. Further, rewards program module 110 may make appropriate deductions, based on the redeemed reward points, from a reward point balance associated with the reward account and/or the transaction account.

Rewards program module 110 may determine if at least one of the redeemed reward or the redeemed reward points qualify for a rewards program bonus. If any of the redeemed reward or the redeemed reward points qualifies for a rewards program bonus, rewards program module 110 may issue the rewards program bonus to the customer. In an embodiment, the amount of the rewards program bonus may be percentage of the redeemed reward points. Rewards program module 110 may correspondingly reflect the accrued rewards program bonus in the reward point balance associated with the reward account and/or the transaction account. In various embodiments, rewards program module 110 may also report, to the customer, the rewards program bonus issued by at least one of, a transaction account statement, an appropriate electronic message, a telephonic call and/or the like.

The invention may be described herein in terms of functional block components, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of network environment 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that network environment 100 may employ any number of conventional techniques for data transmission, signaling, data processing, network control, and/or the like. Still further, network environment 100 could be used to detect or prevent security issues with a client-side scripting language, such as JavaScript, VBScript or the like.

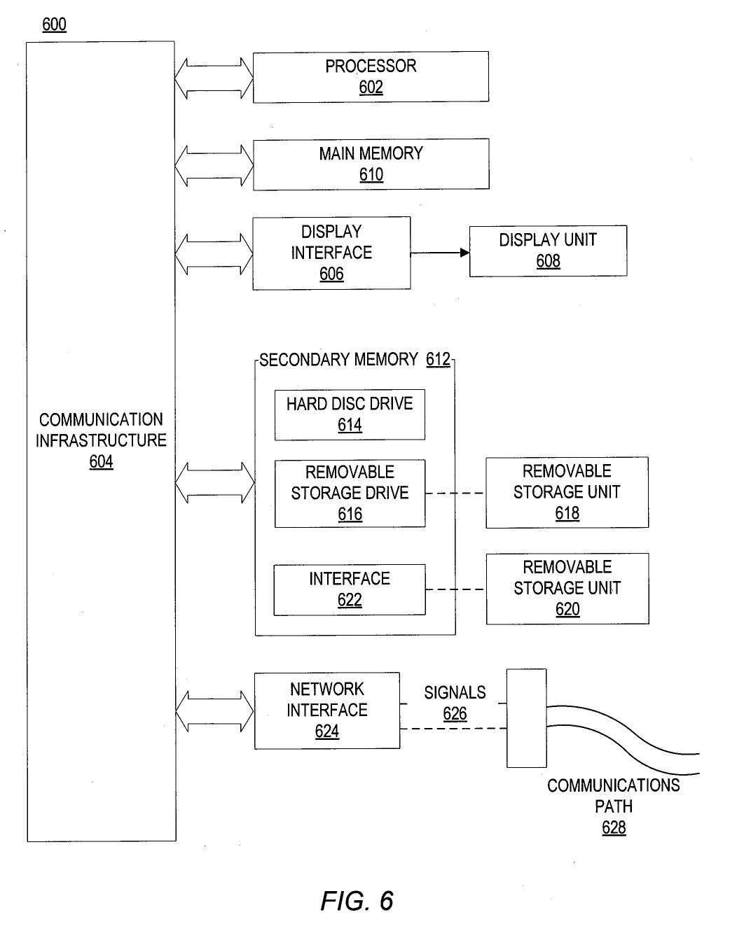

These software elements may be loaded onto a general purpose computer, special purpose computer (explained in conjunction with FIG. 6), or other programmable data processing apparatus to produce a machine, such that the instructions that execute on the computer or other programmable data processing apparatus create means for implementing the functions specified in the flowchart block or blocks. These computer program instructions may also be stored in a computer readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

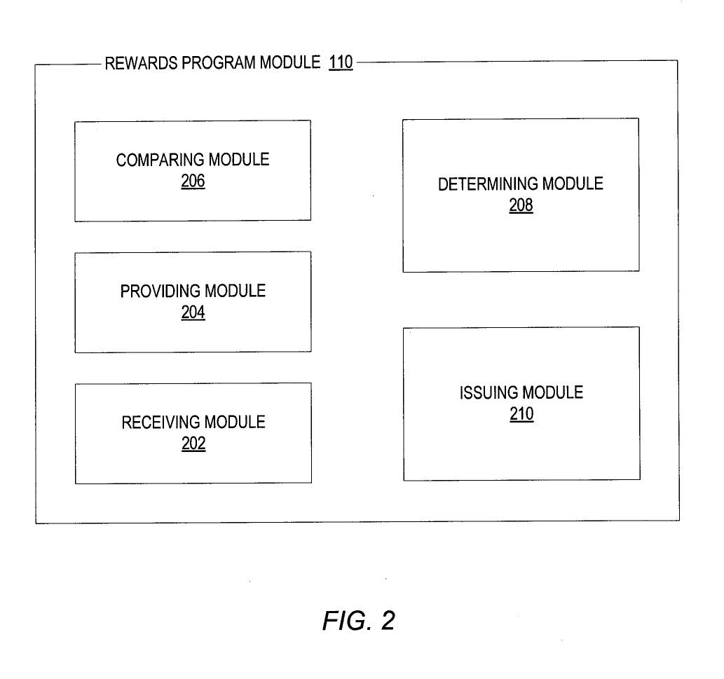

With reference to FIG. 2, rewards program module 110 may include a receiving module 202, a providing module 204, a comparing module 206, a determining module 208 and an issuing module 210, according to an embodiment of the present invention.

Receiving module 202 may receive a request for reward redemption, from the customer, via client node 106. The reward redemption request may be associated with a rewards program. Further, the reward redemption may be requested in exchange of reward points accrued from one or more previous payment transactions and/or are accumulated in the reward account and/or transaction account of the customer. Receiving module 202 may receive the reward redemption request from the POS device of the merchant. In one embodiment, a POS device may be deployed at the merchant's establishment.

Receiving module 202 may authenticate the reward redemption request. The authentication may be based on a number of factors such as, verifying the supplied customer details with that of the stored customer data retrieved from database 112; checking that the reward point balance is sufficient to permit the redemption; ensuring that the reward points are valid or the like.

In one situation, on failure of authentication, the reward redemption request may be rejected. In such a situation, rewards program module 110 may notify the customer about the failure of the redemption by a notification. This notification may be provided by an e-mail, a telephonic call, a prerecorded voice message, or any other electronic message.

In another situation, on successful authentication, providing module 204 may provide the redeemed reward. The redeemed reward may be a good and/or service related to, without limitation, a list of catalog items featured in a hard copy booklet, products available online and/or off-the-shelf in a retail store or the like. Further, depending on the type of the redeemed reward and the mode of request, rewards program module 110 may retrieve, from database 112, information related to the customer, such as, residential details or the like for shipment.

Further, in case the delivery of the redeemed reward to the customer's premise may take a pre-fixed number of days, rewards program module 110 may notify the customer about the successful completion of the redemption and indicate the expected delivery date of the redeemed reward. The notification may be in the form of an electronic message. The electronic message may be an e-mail, Short Messaging Service (SMS), and/or mailing a hard copy of a redemption confirmation letter or the like. Subsequently, rewards program module 110 may make appropriate deductions in the reward point balance to reflect the exchange of the reward points for the redeemed reward.

Comparing module 206 may compare the redeemed reward with redemption criteria. In an embodiment, the redemption criteria may be based on the redeemed reward. In another embodiment, the redemption criteria may be based on the reward points used to redeem the reward. The redemption criteria may thus include, for example, the redeemed rewards that belong to a particular category based on the type of product and/or service; the redeemed rewards that belong to a particular third party service provider or partner; the redeemed rewards that are newly launched or the like. Further, the redemption criteria may also include, for example, a predetermined threshold of points that are redeemed for the reward.

In response to the comparison, determining module 208 may determine if at least one of the redeemed reward or the reward points qualify for a rewards program bonus. In one embodiment, qualification for the rewards program bonus may be based, at least in part on, matching with the redemption criteria. In an exemplary embodiment, the amount of reward points redeemed may need to exceed a pre-defined threshold of points in order to qualify for the rewards program bonus.

The qualification criteria for eligibility to the rewards program bonus may be based at least partially on, at least one of, a percentage of the reward points redeemed in relation to the reward points balance, an amount of reward points redeemed within a predetermined period, the type of reward points redeemed, the redeemed reward, the geographic area where the reward points were earned, type of good, type of service, day of spend, time of day, merchant type, season, class of products, level of spend, amount of spend, or rate of spend. For example, a predetermined period may be any suitable period, such as a billing cycle, a month, a period of weeks, a period of days, and/or a period of minutes. For example, a reward redemption request pertaining to child care products may be entitled to a rewards program bonus. In another example case, a reward redemption request made on a designated day may be entitled to a rewards program bonus.

Further, other qualification criteria may be based, at least partially on, at least one of, the stored rewards program reward points associated with the rewards program, the amount of rewards redeemed within a predetermined period, the frequency with which rewards are redeemed within a predetermined period, the length of time reward points associated with the rewards program are stored in the rewards program, or the number of times the rewards are redeemed within a predetermined period or the like.

In an embodiment, an amount of the rewards program bonus may be a percentage of the redeemed reward points. In an embodiment, an amount of the rewards program bonus may be a flat or pre-selected value set at any suitable time. Further, an amount of the rewards program bonus may also be associated with at least one of a discount, cash back, miles, a clearance, a featured item, travel, entertainment, information, popular item, theme, daily deal, additional reward points and/or loyalty points and/or third party reward points or the like. For example, if the customer requests for a reward redemption in exchange of certain reward points, then the customer may get a pre-defined percentage of redeemed reward points, accrued back into his transaction account. Otherwise, the customer may be provided with one or more vouchers or schemes, which may be used to redeem other rewards/services. Thus, the rewards program bonus may be considered to be the additional benefit(s) provided to the customers on the successful redemption of the reward points.

The rewards program bonus may include, without limitation, at least one of a credit of monetary value to the transaction account and/or the credit of reward points to the reward account and/or transaction account of the customer, whichever is associated with the rewards program. Moreover, the rewards program bonus may also be credited to a third party account and/or a beneficiary of the transaction account.

The amount of the rewards program bonus may be a percentage of the redeemed reward points. Further, the percentage may be fixed and may depend on, for example, the type of transaction instrument, season of redemption, type of redemption or the like. For example, as one of the criteria in rewards program bonus, all platinum card holders are given a pre-defined 20% of the redeemed reward points under the rewards program bonus, on redemption of more than 1,000 reward points.

The rewards program bonus may be a percentage of the reward redeemed, such that, without limitation, the amount of the percentage is a function of the amount of previous rewards program bonuses accrued within a predetermined period. For example, in a previous reward redemption related to holiday accommodation, a customer received a 4% rewards program bonus. On a subsequent reward redemption related to holiday accommodation, the customer may be given an increased 6% rewards program bonus.

A suitable notification may be provided to the customer and/or transaction account holder of an available rewards program bonus associated with at least one of successful reward redemption, the reward redemption within a predetermined period or the like. The notification may be provided by means of, for example, a telephone call, an SMS, an e-mail, any other electronic message delivery service, a hard copy letter or the like. For example, the customer may be sent an e-mail informing the latest rewards program bonus associated with his transaction account and the various qualification criteria (described above) for eligibility to the rewards program bonus.

The rewards program bonuses that are earned from the reward redemptions and/or the transactions in a geographic area are redeemable in the same geographic area. For example, if a customer redeems 20,000 reward points on basketball tickets in New York, he may earn 4,000 points as a rewards program bonus redeemable in selected food outlets or restaurants in New York itself In other embodiments, the rewards program bonus earned from the redemptions and/or the transactions in a first geographic area may be redeemable in a second geographic area.

In response to qualifying for the rewards program bonus, issuing module 210 may issue the rewards program bonus. Rewards program module 110 may reflect an increase in the reward points balance, by adding up the amount of the rewards program bonus, associated with the reward account and/or transaction account. The rewards program bonus may be issued as a reward to a third party account and/or to the beneficiary of the transaction account.

Either on receiving a request for the reward redemption or on successful redemption of the reward, rewards program module 110 may notify the customer of the availability of an increased rewards program bonus. The increased reward program bonus may be based on redemption of a second reward in exchange of at least a second amount of reward points within a predetermined period. For example, if a customer redeems 20,000 reward points on certain purchases, the customer may receive a notification stating that if the customer is willing to redeem an additional 15,000 reward points for a second reward, within a predetermined period, then the customer may be eligible for an increased rewards program bonus. In other words, if the customer is eligible for 4% rewards program bonus on redemption of 20,000 points, and if the customer is willing to redeem another 15,000 points for the second reward, then the customer may be eligible for 6% rewards program bonus on the additional 15,000 points.

A second reward redemption in association with the reward program may be combined with the earlier reward redemption associated with rewards program to increase the rewards program bonus. Further, the combining may be possible within a predetermined period. For example, if the rewards program bonus is set at 4% of the redeemed points above 20,000, and 1% of the redeemed points above 10,000, two instances of reward redemption, within a predetermined period, in exchange for total reward points (summation of reward points for first reward and second reward) of at least 20000 may be combined to provide an increased rewards program bonus of 4%.

The combining may be accomplished, within a predetermined period, to qualify for the rewards program bonus. For example, if the qualification criteria is fixed at a minimum of 20,000 points (with a rewards program bonus set as 4% of the redeemed reward points), then a first reward redemption of at least 10,000 reward points and a second reward redemption of at least 10,000 reward points may be combined, within a predetermined period, to qualify for the rewards program bonus.

The rewards program bonus may be customized in conjunction with spend data associated with the transaction account of the customer. The spend data may include the type of products and/or services purchased by the customer, the vendor or merchant name, the date of purchase or the like.

Rewards program module 110 may continuously monitor the spend data associated with the transaction account of the customer and further dynamically populate database 112 with the information related to the spend data. Additionally, rewards program module 110 may classify the data with an identifier. The identifier may classify the spend data based on one or more parameters. The identifier may include, but not is limited to, at least one of, type of good, type of service, geographic area, day of spend, time of day, merchant type, season, class of products, level of spend, amount of spend, rate of spend or the like.

In response to receiving the reward redemption request, rewards program module 110 may retrieve the spend data from database 112. Rewards program module 110 may analyze the spend data of the customer. Further, rewards program module 110 may determine a second rewards program bonus associated with the spend data. The second program bonus is in addition to the rewards program bonus offered to the customer. The second rewards program bonus associated with the spend data may be determined based on the identifier associated with the spend data. Subsequently, the determined second rewards program bonus is issued to the customer and suitably reflected in the reward point balance.

Thus, the second rewards program bonus may include the additional benefit(s) offered to the customer based on the one or more previous payment transactions and/or the reward redemptions conducted. Further, by monitoring and analyzing the spending trends of the customer, the second rewards program bonus may include incentives that are closer to the customer's spending tendency. For example, on monitoring and analyzing the past payment transactions conducted via a customer's credit card, rewards program module 110 may understand that the customer is a frequent flier. Accordingly, rewards program module 110 may determine the second rewards program bonus in the form of air mile bonus points, air mile vouchers or the like for the customer.

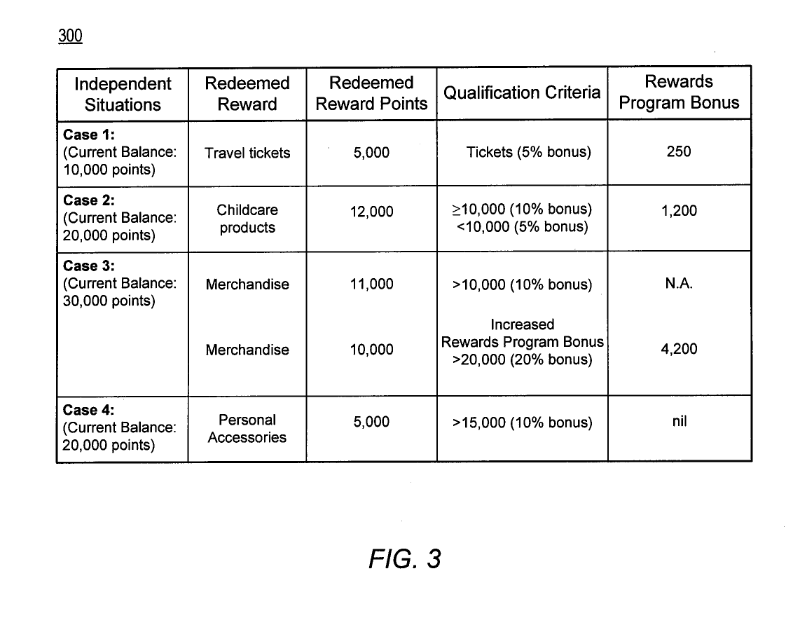

With reference to FIG. 3, exemplary situations include four independent cases associated with the rewards program. In exemplary case 1, the reward point balance may be 10,000 points. As illustrated in the exemplary case 1, the customer requests for travel tickets redemption in exchange of 5,000 reward points. Subsequently, suitable deduction in the reward point balance may be made to reflect the successful reward redemption. Further, it is determined if the redeemed reward and/or redeemed reward points satisfy a qualification criteria associated with the rewards program bonus. In exemplary case 1, the qualification criteria may include 5% bonus reward points on redeemed reward, which may include all types of “tickets” such as movie tickets, travel tickets, or the like.

Since the redeemed reward of “travel tickets” meets the qualification criteria of “tickets”, it is determined that exemplary case 1 qualifies for the reward program bonus. Thus, the reward program bonus is issued and 250 reward points are rewarded to the customer. Further, the corresponding change may be suitably reflected in the reward point balance associated with the reward account and/or transaction account of the customer. Hence, the reward point balance in exemplary case 1 is 5,250 points.

In exemplary case 2, the reward point balance may be 20,000 points. As illustrated in the exemplary case 2, the customer requests for the rewards redemption (childcare products) in exchange of 12,000 reward points. Subsequently, suitable deduction in the reward point balance may be made to reflect the successful reward redemption.

Further, it is determined if the redeemed reward and/or the reward points balance satisfy a qualification criteria associated with the rewards program bonus. In exemplary case 2, the qualification criteria may include 10% bonus if redeemed reward points are greater than 10,000 points else 5% bonus if the redeemed reward points are lesser than 10,000 points. Since the redeemed reward points (12000) satisfy the criteria of 10% bonus, 1,200 reward points are rewarded to the customer. Further, the corresponding change may be suitably reflected in the reward points balance associated with the reward account and/or transaction account of the customer. Hence, the reward points balance in exemplary case 2 is 9,200 points.

In exemplary case 3, the reward points balance may be 30,000 points. As illustrated in the exemplary case 3, the customer request for a reward redemption (certain merchandise) in exchange of 11,000 reward points. Suitable deduction in the reward point balance may be made to reflect the successful reward redemption. Further, it is determined if the redeemed reward and/or the reward point balance satisfy a qualification criteria associated with the rewards program bonus. In the exemplary case 3, the qualification criteria may include 10% bonus if redeemed reward points are greater than 10,000 points. Further, there is an opportunity to receive an increased rewards program bonus of 20% if the redeemed reward points, redeemed within a predetermined period, equals to at least 20,000 points. Subsequently, the customer may be informed that he/she may receive the increased rewards program bonus if the customer redeems 9,000 extra points within a predetermined period. As illustrated in exemplary 3, the customer requests for another reward in exchange of 10,000 points. Since, the total redeemed reward points (21,000, combining the first and second redemption requests) occur within the stipulated period of time, the criteria of increased rewards program bonus of 20% is satisfied and 4,200 reward points are rewarded to the customer. Further, the corresponding change may be suitably reflected in the reward point balance associated with the reward account and/or transaction account of the customer. Hence, the reward point balance in exemplary case 3 is 13200 points.

In exemplary case 4, the reward point balance may be 20,000 points. As illustrated in the exemplary case 4, the customer request for reward redemption (personal accessories) in exchange of 5,000 reward points. In another embodiment, the request for reward redemption can be an automatic request based on a predetermined threshold and/or trigger, such as a reward point balance reaching a preset threshold. Subsequently, suitable deduction in the reward point balance may be made to reflect the successful reward redemption. Further, it is determined if the redeemed reward and/or the reward points balance satisfy a qualification criteria associated with the rewards program bonus. In the exemplary case 4, the qualification criteria may include 10% bonus if redeemed reward points are greater than 15,000 points. Since, the redeemed reward points (5,000) does not satisfy the qualification criteria, rewards program bonus is not issued to the customer. Hence, the reward point balance in exemplary case 4 is 15,000 points.

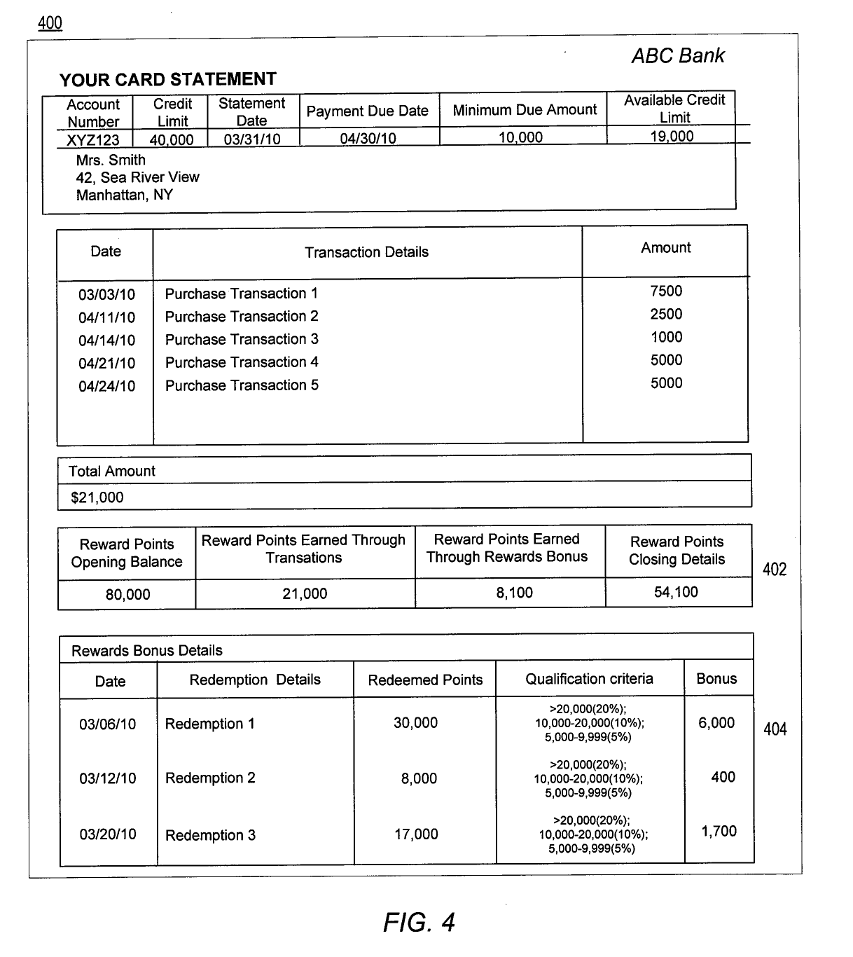

With reference to FIG. 4, an exemplary transaction account statement is illustrated. The given exemplary transaction account statement may be a monthly account balance statement provided by transaction based service provider 102. Those of ordinarily skill in the art will appreciate that the given statement is merely an example illustration depicting a sample notification to report the credit of a rewards program bonus to the reward account and/or the transaction account of the customer. The numbers and data shown in the statement, and the statement itself are merely on an illustrative basis and do not limit the scope of the present invention.

As illustrated in table 402, the reward points opening balance of the customer is 80,000 points. Further, in an exemplary embodiment, the customer may be rewarded 1 reward point on expenditure of $10. Thus, as illustrated in the table 402, the customer may be rewarded 2, 100 reward points during the month based on the total transactions of $21,000. Further, table 402 depicts reward points earned through a reward program bonus. The details of the reward program bonus are illustrated in table 404.

During the month, the customer redeems reward points in exchange of one or more redeemed rewards. In an embodiment, the redeemed rewards may include, but are not limited to, a monetary reward, a discount on a pre-listed catalog of products and/or services or the like. The one or more redemptions made by the customer during the month are illustrated in table 404. Table 404 illustrates a first, second and a third redemption along with the redeemed reward points and the corresponding rewards program bonus earned in each of the redemptions. As per table 404, the customer redeems 30,000 points in the first redemption and 10,000 points and 20,000 points in the second and third reward redemptions respectively.

As illustrated in table 404, the qualification criteria for the rewards program bonus may include a 5% bonus on redeemed reward points from 5,000-10,000, and 10% and 20% bonus on redeemed reward points from 10,000-20,000 and at least 20,000 respectively. Based on the qualification criteria, as illustrated in table 404, the customer may be rewarded 6000 reward point bonus for first redemption and 400 and 1,700 reward points for second and third redemptions respectively.

Thus, as depicted in table 402, the reward points earned through the rewards program bonus in the first, the second and the third reward redemptions are 8,100 points. Further, the total reward points redeemed during the course of the month are 55,000 points. Hence, as depicted in table 402, the closing reward point balance at the end of the month is 35,200 points.

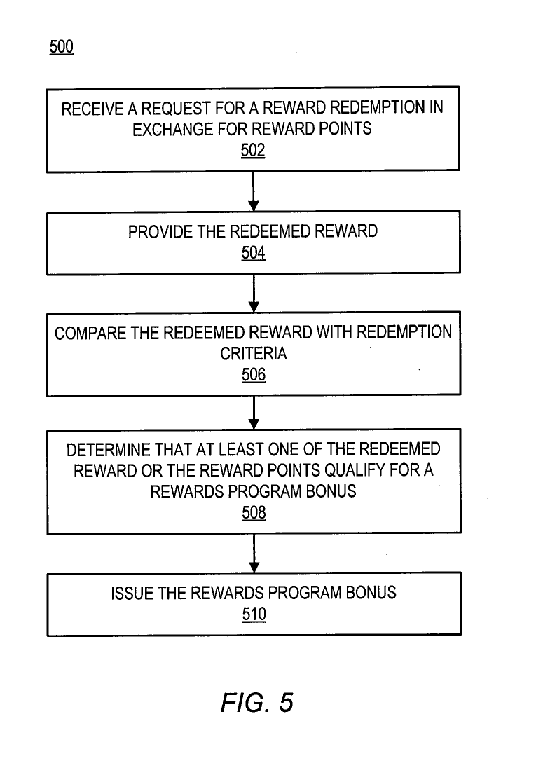

With reference to FIG. 5, a rewards program management process 500 may be automatically invoked at defined periods or randomly, according to various embodiments. Rewards program module 110 may receive a request, from the customer, for reward redemption in exchange for reward points in association with the rewards program (step 502).

Rewards program module 110 may provide the redeemed reward (step 504). In an embodiment, the redeemed reward may be a good and/or service related to, without limitation, a list of catalog items featured in a hard copy booklet, products available online and/or off-the-shelf in a retail store and the like. Further, rewards program module 110 may make appropriate deductions in the reward point balance to reflect the exchange of the reward points for the redeemed reward.

Rewards program module 110 may compare the redeemed reward with redemption criteria (step 506). In an embodiment of the present invention, the redemption criteria may be based on the redeemed reward. The redemption criteria may thus include, for example, the redeemed rewards that belong to a particular category based on the type of product and/or service; the redeemed rewards that belong to a particular third party service provider, or partner; the redeemed rewards that are newly launched and the like. Rewards program module 110 may further determine if at least one of the redeemed reward or the redeemed reward points qualify for a rewards program bonus (step 508).

In an embodiment, the qualification criteria for eligibility to the rewards program bonus may be based at least partially on, at least one of, a percentage of the reward points redeemed in relation to the reward points balance, an amount of reward points redeemed within a predetermined period, the redeemed reward, the geographic area where the reward points were earned, type of good, purchased type of service, purchased day of spend, transaction time of day, transaction merchant type, season of transaction, class of products purchased, customer's level of spend, customer's amount of spend, or rate of customer's spend. For example, a reward redemption request pertaining to child care products may be entitled to a rewards program bonus. In another example case, a reward redemption request made on a designated day may be entitled to a rewards program bonus.

Further, other qualification criteria may be based, at least partially on, at least one of, the stored rewards program reward points associated with the rewards program, the amount of rewards redeemed within a predetermined period, the frequency with which rewards are redeemed within a predetermined period, the length of time reward points associated with the rewards program are stored in the rewards program, or the number of times the rewards are redeemed within a predetermined period or the like.

In an embodiment, an amount of the rewards program bonus may be a percentage of the redeemed reward points. Further, an amount of the rewards program bonus may also be associated with at least one of, for example, a discount, a clearance, a featured item, travel, entertainment, information, popular item, theme, daily deal, additional reward points and/or third party reward points or the like. In an embodiment, the rewards program bonus may include, for example, at least one of a credit of monetary value to the transaction account and/or the credit of reward points to the reward account and/or transaction account of the customer, whichever is associated with the rewards program. Moreover, the rewards or a selectable portion of the program bonus may also be credited to a third party account and/or a beneficiary of the transaction account.

In an embodiment, the amount of the rewards program bonus may be a percentage of the redeemed reward points. Further, the percentage may be fixed and may depend on, for example, the type of transaction instrument, season of redemption, type of redemption, type of transaction account, tenure of transaction account or the like. The rewards program bonus may be a percentage of the reward redeemed, such that the amount of the percentage is a function of the amount of previous rewards program bonuses accrued within a predetermined period.

In an embodiment, a suitable notification may be provided to the customer and/or transaction account holder of an available rewards program bonus associated with at least one of successful reward redemption, and the reward redemption within a predetermined period or the like.

In an embodiment, the rewards program bonuses that are earned from the reward redemptions and/or the transactions in a geographic area are redeemable in the same geographic area.

In response to qualifying for the rewards program bonus, rewards program module 110 may issue the rewards program bonus (step 510).

In an embodiment, either on receiving a request for the reward redemption or on successful redemption of the reward, rewards program module 110 may notify the customer of the availability of an increased rewards program bonus program. The increased reward program bonus may be based on redemption of a second reward in exchange of at least a second amount of reward points within a predetermined period. In an embodiment, a second reward redemption in association with the reward program may be combined with the earlier reward redemption associated with rewards program to increase the rewards program bonus.

In an embodiment, rewards program bonus may be customized in conjunction with spend data associated with the transaction account of the customer. The spend data may include the type of products and/or services purchased by the customer, the vendor or merchant name, the date of purchase or the like.

In an embodiment, rewards program module 110 may continuously monitor the spend data associated with the transaction account of the customer and further dynamically populate database 112 with the information related to the spend data. Additionally, rewards program module 110 may classify the data with an identifier. The identifier may classify the spend data based on one or more parameters. The identifier may include, for example, at least one of, type of good, type of service, geographic area, day of spend, time of day, merchant type, season, class of products, level of spend, amount of spend, rate of spend or the like.

In an exemplary embodiment, in response to receiving the reward redemption request, rewards program module 110 may retrieve the spend data from database 112. Rewards program module 110 may analyze the spend data based of the customer. Further, rewards program module 110 may determine a second rewards program bonus associated with the spend data. In an embodiment, the second program bonus is in addition to the rewards program bonus offered to the customer. The second rewards program bonus associated with the spend data may be determined based on the identifier associated with the spend data. The determined second rewards program bonus is issued to the customer and suitably reflected in the reward point balance.

Aspects of the present invention (i.e., service provider 102, module 110, process 500, or any part(s) or function(s) thereof) may be implemented using hardware, software or a combination thereof, and may be implemented in one or more computer based systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or particular computing devices.

In fact, in accordance with an embodiment of the present invention, the present invention is directed towards one or more computer based systems capable of carrying out the functionality described herein. An example of the computer based system includes a computer based system 600, which is shown in FIG. 6.

In one embodiment, computer based system 600 includes a network interface 624 communicating with a memory via a communication infrastructure 604. Further, the memory communicates with a processor 602. Processor 602 is connected to communication infrastructure 604 which may include a communications bus, a cross over bar, a network, and the like. Various software embodiments are described in terms of exemplary computer based system 600. After reading this description, it will become apparent to a person skilled in the relevant art(s) how to implement the present invention using other computer based systems and/or architectures. Computer based system 600 includes a display interface 606 that forwards graphics, text, and other data from communication infrastructure 604 (or from a frame buffer which is not shown in FIG. 6) for display on a display unit 608.

The memory further includes a main memory 610, such as random access memory (RAM), and may also include a secondary memory 612. Secondary memory 612 may further include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a well known manner. Removable storage unit 618 may represent a floppy disk, magnetic tape or an optical disk, and may be read by and written to by removable storage drive 616. As will be appreciated, removable storage unit 618 includes a tangible, non-transitory computer readable storage medium having stored thereon computer-executable instructions computer software and/or data.

In accordance with various embodiments, secondary memory 612 may include other similar devices for allowing the computer-executable instructions or other computer programs to be loaded into computer based system 600. Such devices may include, for example, a removable storage unit 620, and an interface 622. Examples of such may include a program cartridge and cartridge interface (such as that found in video game devices), a removable memory chip (such as an erasable programmable read only memory (EPROM), or programmable read only memory (PROM)) and associated socket, and other removable storage units 620 and interfaces 622, which allow software and data to be transferred from removable storage unit 620 to computer based system 600.

Computer based system 600 may further include network interface 624. Network interface 624 allows software and data to be transferred between computer based system 600 and external devices. Examples of network interface 624 include, for example, a modem, an Ethernet card, a communications port, a Personal Computer Memory Card International Association (PCMCIA) slot and card, and the like. Software and data transferred via network interface 624 are in the form of a plurality of signals, hereinafter referred to as signals 626, which may be electronic, electromagnetic, optical or other signals capable of being received by network interface 624. Signals 626 are provided to network interface 624 via a communication path (e.g., channel) 628. A communication path 628 carries signals 626 and may be implemented using wire or cable, fiber optics, a telephone line, a cellular link, a radio frequency (RF) link and other communication channels.

In this document, the terms “computer program medium” and “computer usable medium” are used to generally refer to media such as removable storage drive 616, hard disk installed in hard disk drive 614, signals 626, and the like. These tangible, non-transitory computer-readable storage mediums provide software in the form of computer-executable instructions to computer based system 600. The present invention is directed to such computer-readable storage mediums.

Computer programs (also referred to as computer-executable instructions) are stored in main memory 610 and/or secondary memory 612. Computer programs may also be received via communication infrastructure 604. Such computer programs, when executed, enable computer based system 600 to perform the operations of the present invention, as discussed herein. In particular, the computer programs, when executed, enable processor 602 to perform the operations of the present invention. Accordingly, such computer programs represent controllers of computer based system 600.

In accordance with an embodiment of the invention, where the invention is implemented using a software, the software may be stored in a computer program and loaded into computer based system 600 using removable storage drive 616, hard disk drive 614 or network interface 624. The computer-executable instructions (software), when executed by processor 602, causes processor 602 to perform the operations of the present invention as described herein.

In another embodiment, the present invention is implemented primarily in hardware using, for example, hardware components such as application specific integrated circuits (ASIC). In yet another embodiment, the present invention is implemented using a combination of both the hardware and the software.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

The computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method, comprising:
receiving, by a computer based system for managing a rewards program, a request for a reward redemption in exchange for reward points, in association with the rewards program;
providing, by the computer based system, the redeemed reward;
comparing, by the computer based system, the redeemed reward with redemption criteria, wherein the redemption criteria is based on the attributes of the redeemed reward;
determining, by the computer based system, that at least one of the redeemed reward or the reward points qualify for a rewards program bonus;
issuing, by the computer based system, the rewards program bonus as a credit of reward points to a reward program account associated with the reward redemption.

2. The method of claim 1, wherein the amount of the rewards program bonus is at least one of a percentage of the redeemed reward points and a preselected value.

3. The method of claim 1, wherein the amount of the rewards program bonus is a percentage of the reward points, and wherein the amount of the percentage is a function of the amount of previous rewards program bonuses accrued within a predetermined period.

4. The method of claim 1, further comprising reporting, by the computer based system, the rewards program bonus on a transaction account statement associated with at least one of the rewards program or the transaction account.

5. (canceled)

6. The method of claim 1, wherein the rewards program bonus is based at least partially on at least one of: a percentage of reward points redeemed in relation to a balance of reward points, an amount of reward points redeemed within a predetermined period, the type of reward points redeemed, the redeemed reward, the geographic region where the reward points were earned, type of good, type of service, day of spend, time of day, merchant type, season, class of products, level of spend, amount of spend, or rate of spend.

7. The method of claim 1, wherein the rewards program bonus is based at least partially on at least one of: stored rewards program reward points associated with a rewards program, the amount of rewards redeemed within a predetermined period, the frequency rewards are redeemed within a predetermined period, the length of time rewards program reward points associated with a rewards program are stored in a rewards program, or the amount of times rewards are redeemed within a predetermined period.

8. The method of claim 1, further comprising associating, by the computer based system, a transaction account with the rewards program.

9. The method of claim 1, further comprising notifying, by the computer based system, a transaction account holder of an available rewards program bonus associated with at least one of successful reward redemption and reward redemption within a predetermined period.

10. (canceled)

11. The method of claim 1, wherein the rewards program bonus is earned from transactions in a geographic area and is redeemable in the geographic area.

12. The method of claim 1, wherein the rewards program bonus is earned from transactions in a first geographic area and is redeemable in a second geographic area.

13. The method of claim 1, further comprising:
monitoring, by the computer based system, spend data associated with the transaction account;
analyzing, by the computer based system, the spend data;
determining, by the computer based system, a second rewards program bonus associated with the spend data based on an identifier associated with the spend data;
issuing, by the computer based system, the determined second rewards program bonus.

14. The method of claim 13, wherein the identifier associated with the spend data comprises at least one of: type of good, type of service, geographic area, day of spend, time of day, merchant type, season, class of products, level of spend, amount of spend, or rate of spend.

15. The method of claim 1, further comprising notifying, by the computer based system, in response to the reward redemption, of the availability of an increased rewards program bonus for a reward redemption of a second amount within a predetermined period.

16. The method of claim 1, wherein a second redeeming of a reward associated with the rewards program may be combined with the redeeming of the reward associated with the rewards program to increase the reward program bonus.

17. The method of claim 16, wherein the combining is performed within a predetermined period.

18. (canceled)

19. The method of claim 1, wherein the request for the reward redemption in exchange for reward points is at least one of based on a request received from a transaction account holder or an automatic request based the reward points reaching a predetermined threshold.

20. A tangible, non-transitory computer-readable storage medium having computer-executable instructions stored thereon that, in response to execution by a computer based system for managing a rewards program, causes the computer based system to perform operations comprising:
receiving, by the computer based system, a request for a reward redemption in exchange for reward points, in association with the rewards program;
providing, by the computer based system, the redeemed reward;
comparing, by the computer based system, the redeemed reward with redemption criteria, wherein the redemption criteria is based on the attributes of the redeemed reward;
determining, by the computer based system, that at least one of the redeemed reward or the reward points qualify for a rewards program bonus;
issuing, by the computer based system, the rewards program bonus as a credit of reward points to a reward program account associated with the reward redemption.

21. A computer based system for managing a rewards program comprising:
a network interface communicating with a memory;
the memory communicating with a processor for managing a rewards program; and
the processor, when executing a computer program, performs operations comprising:
receiving, by the computer based system, a request for a reward redemption in exchange for reward points, in association with the rewards program;
providing, by the computer based system, the redeemed reward;
comparing, by the computer based system, the redeemed reward with redemption criteria, wherein the redemption criteria is based on the attributes of the redeemed reward;
determining, by the computer based system, that at least one of the redeemed reward or the reward points qualify for a rewards program bonus;
issuing, by the computer based system, the rewards program bonus as a credit of reward points to a reward program account associated with the reward redemption.
